(19) United States
(12) Patent Application Publication
(10) Pub. No.: US 2015/0230180 A1
(43) Pub. Date: Aug. 13, 2015

(54) COMMUNICATION METHOD FOR EFFICIENT POWER SAVING OF UE-RELAY OPERATION USING D2D DISCOVERY IN CELLULAR SYSTEM

(71) Applicant: Samsung Electronics Co., Ltd., Gyeonggi-do (KR)

(72) Inventors: Chiwoo Lim, Gyeonggi-do (KR); Hyunseok Ryu, Gyeonggi-do (KR); Seunghoon Park, Seoul (KR)

(21) Appl. No.: 14/620,109

(22) Filed: Feb. 11, 2015

(30) Foreign Application Priority Data
Feb. 11, 2014 (KR) 10-2014-0015469

(51) Int. Cl. H04W 52/02; H04W 88/04; H04W 76/06; H04W 76/02

(52) U.S. Cl. CPC H04W 52/0235; H04W 76/023; H04W 88/04; H04W 76/064

(57) ABSTRACT

Disclosed are a communication method and a terminal for power saving in a UE-relay operation by which power consumption in a device relay is reduced using D2D discovery. The relay communication method of a terminal is provided. The method includes performing relay communication to serve at least one other terminal; performing a device-to-device (D2D) discovery operation to detect a nearby relay terminal during the relay communication; and if the nearby relay terminal that satisfies a predetermined condition is detected as a result of the D2D discovery operation, terminating service to at least the one other terminal.

### CROSS-REFERENCE TO RELATED APPLICATION(S) AND CLAIM OF PRIORITY

The present application is related to and claims priority from and the benefit under 35 U.S.C. §119(a) of Korean Patent Application No. 10-2014-0015469, filed on Feb. 11, 2014, which is hereby incorporated by reference for all purposes as if fully set forth herein.

### TECHNICAL FIELD

The present disclosure relates generally to a communication method for power saving in a UE-relay operation, and more particularly, to a communication method and a terminal by which power consumption in a device relay can be reduced by using D2D discovery.

### BACKGROUND

Recently, the UE-relay operation in the cellular system has been researched. Particularly, the UE-relay operation plays an important role in public safety. Meanwhile, the UE-relay operation has big issues with power consumption. That is, a relay terminal that serves at least one of other terminals continues to transmit and receive periodic reference signals and data to and from other terminals that are being served during the UE-relay operation, so power consumption of a battery increases. Therefore, it is important to provide a method for power saving of the relay terminal in the UE-relay operation.

### SUMMARY

To address the above-discussed deficiencies, it is a primary object to provide a method for effectively reducing power consumption of the relay terminal in UE-relay communication. In a first example, a relay communication method of a first terminal is provided. The method includes performing relay communication to serve at least one other terminal; performing a device-to-device (D2D) discovery operation to detect a nearby relay terminal during the relay communication; and if the nearby relay terminal that satisfies a predetermined condition is detected as a result of the D2D discovery operation, terminating service to at least the one other terminal.

In a second example, a terminal that performs relay communication is provided. The terminal includes a communication unit configured to perform data-communication; and a control unit configured to: perform relay communication to serve at least one other terminal, perform a device-to-device (D2D) discovery operation to detect a nearby relay terminal during the relay communication, and if the nearby relay terminal that satisfies a predetermined condition is detected as a result of the discovery operation, terminate service to at least the one other terminal. According to embodiments of the present disclosure, power consumption of the relay terminal in the UE-relay operation is reduced using a discovery range between devices in D2D communication. Particularly, power consumption according to the present disclosure is maximized in the case of a plurality of relay terminals. In addition, according to the present disclosure, the power saving operation can be performed according to battery status of the relay terminal. At this time, the relay terminal may bear additional overhead as in the typical discovery operation. The effect of the present disclosure is based on the assumption that joining the discovery operation needs less power than serving other terminals.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flowchart illustrating an example communication method for reducing power consumption according to this disclosure;

FIG. 2 is a flowchart illustrating an example communication method for reducing power consumption according to this disclosure;

FIG. 3 illustrates an example cellular system according to this disclosure;

FIG. 4 is a flowchart illustrating an example method of UE-relay communication for reducing power consumption according to this disclosure; and

FIG. 5 is a block diagram of an example terminal and an example base station for performing operations according to this disclosure.

### DETAILED DESCRIPTION

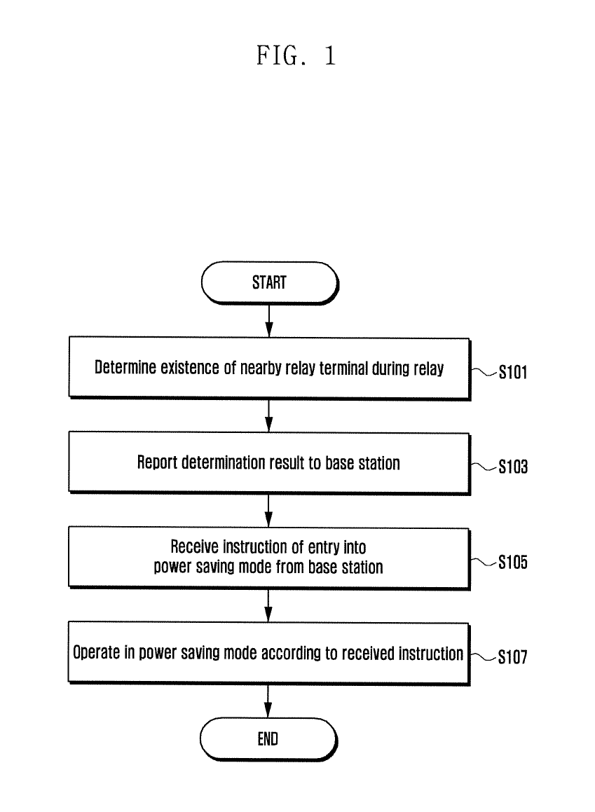

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device and communication system.

Embodiments of the present disclosure can be applied to the next generation mobile communication system of the third generation partnership project (3GPP), i.e., Long Term Evolution (LTE)/LTE-Advanced (LTE-A). Embodiments of the present disclosure will be described in relation to terminals. The terminals can encompass subscriber units, subscriber stations, mobile stations, mobiles, remote stations, remote terminals, mobile devices, user devices, terminals, wireless communication devices, user agents, user devices, user equipments (UE), or the like. The terminals can be cellular phones, personal digital assistants, hand-held devices capable of making wireless communication, computing devices, other processing devices that are connected with wireless modems, or the like.

It should be noted that the technical terms in the specification are merely used for describing a specific embodiment but do not limit the scope of the present disclosure. Further, the technical terms in the specification should be construed as a meaning generally understood by those skilled in the art unless the terms are defined as another meaning and should not be construed as an excessively inclusive meaning or an excessively exclusive meaning.

In addition, a singular expression used in the specification includes a plural expression as long as they are clearly distinguished in the context. Throughout the specification, the terms such as “comprise” or “include” should not be construed as necessarily including all of the various component or steps described in the specification. Throughout the specification, the terms such as “comprise” or “include” should not be construed as necessarily including all of the various component or steps described in the specification.

Hereinafter, exemplary embodiments of the present disclosure will be described with reference to the accompanying drawings. Further, in the following description of the present disclosure, a detailed description of known functions and configurations incorporated herein will be omitted when it may make the subject matter of the present disclosure rather unclear. Terms described later are defined in consideration of functions of the present disclosure, but may vary according to the intention or convention of a user or operator. Therefore, the definitions of the terms should be determined based on the contents throughout the specification.

In order to reduce power consumption, the relay terminal has been operated with the help of the base station or according to a self-imposed condition. FIG. 1 illustrates an example method by which the relay terminal reduces power consumption with the help of the base station according to this disclosure. Hereinafter, the relay terminal denotes the terminal that directly communicates with the base station and serves other terminals with relay communication. A plurality of relay terminals are connected with the network, and each of the relay terminals serve at least one of the other terminals.

As shown in FIG. 1, the base station preliminary informs the relay terminal of a specific timing pattern to identify the existence of other relay terminals near thereto. Based on the timing pattern, the relay terminal determines the existence of nearby relay terminals during the relay operation in block S101, and reports the determination result to the base station in block S103. The base station determines whether or not the relay terminal should be operated in a power saving mode according to the determination result. When information on a power saving state is received from the base station in block 105, the relay terminal operates in the power saving mode in block S107. At this time, the sub-frame muting method is basically utilized.

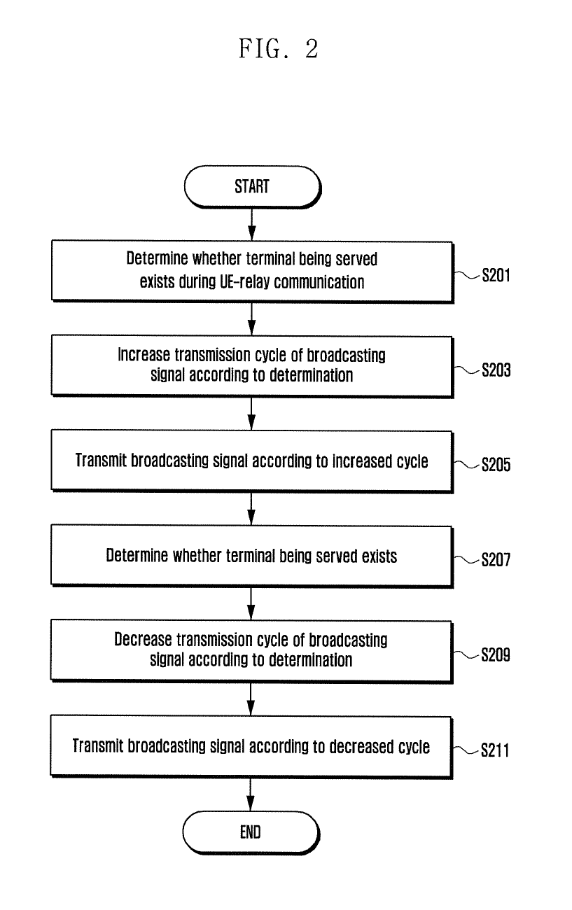

FIG. 2 illustrates an example method by which the relay terminal operates by itself to reduce power consumption according to this disclosure. As shown in FIG. 2, the relay terminal determines whether or not a terminal that is served by the relay terminal exists in block S201, and if the terminal served by the relay terminal does not exist, the relay terminal automatically performs DRX. For example, if the terminal served by the relay terminal does not exist, the relay terminal increases the relay preamble transmission cycle to thereby reduce power consumption in block S203 and in block S205. In contrast, if at least one terminal served by the relay terminal exists in block S207, the relay terminal decreases the relay preamble transmission cycle in block S209, and transmits broadcasting signals according to the changed transmission cycle in block S211.

Due to the reliance on the base station, the base station should allot a specific pattern to the relay terminal. Such an allotment results in severe overhead. Furthermore, if the base station does not exactly identify the location of each relay terminal, allotting the pattern is difficult. In addition, in the self-power saving operation mode, if at least one terminal served by the relay terminal exists, the relay terminal cannot perform the power saving operation. Accordingly, a more effective method, by which the relay terminal can reduce power consumption with a plurality of relay terminals near thereto, is required.

Device-to-device communication (D2D) allows a terminal to directly communicate with other terminals near thereto. Using D2D communication technology, the terminal discovers other terminals near thereto (D2D discovery, D2D-D), and directly communicates with the desired terminal (direct communication, D2D-C). D2D communication manages wireless resources more effectively than typical communication through the base station using wireless networks. In addition, according to the D2D communication, the terminal provides the necessary information to the desired terminal using the method of discovering other terminals around the terminal, so the D2D communication can enhance efficiency of supporting social networking services (hereinafter, referred to as “SNS”) and commercial advertising services. Even though the direct communication is ruled out of cellular communication, the D2D discovery operation can continue to be used. Therefore, power saving using the discovery operation can be still considered in D2D communication.

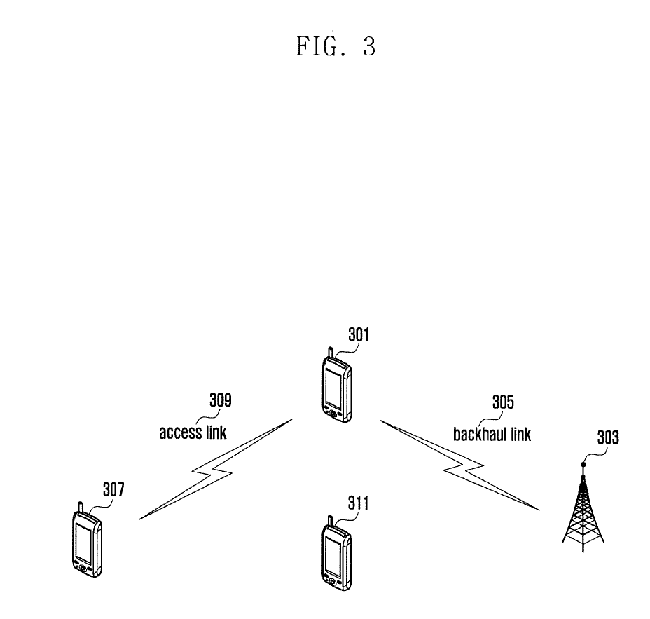

FIG. 3 illustrates an example cellular system according to this disclosure. Referring to FIG. 3, the terminals perform UE-relay communication of device-to-device communication (hereinafter, referred to as D2D communication) in a cellular system. The relay terminal (or serving terminal) 301 is connected with a base station 303 through backhaul link 305 during the UE-relay communication. In addition, the relay terminal 301 is connected with at least one nearby terminal 307 through access link 309. The relay terminal 301 serves the nearby terminals 307 on behalf of the base station 303.

In an embodiment of the present disclosure, the relay terminal 301 performs a D2D discovery operation. Therefore, the relay terminal 301 recognizes the existence of other relay terminals 311 near to the relay terminal 301 by using D2D discovery resources. At this time, the base station 303 does not need to inform the relay terminal 301 of a specific pattern for discovery, and the relay terminal 301 periodically performs the D2D discovery operation to thereby identify whether or not other relay terminals 311 exist near the relay terminal 301. In addition to the identification of the nearby relay terminal 311 through the D2D discovery operation, the relay terminal 301 identifies periodic transmission information of the nearby relay terminal 311, and identifies whether or not the relay terminal 301 serves the terminals 307 on behalf of the nearby relay terminal. In an embodiment of the present disclosure, the relay terminals perform various operations to reduce power consumption through D2D discovery. Hereinafter, the operation of the terminal for reducing power consumption will be described in detail with reference to the drawings.

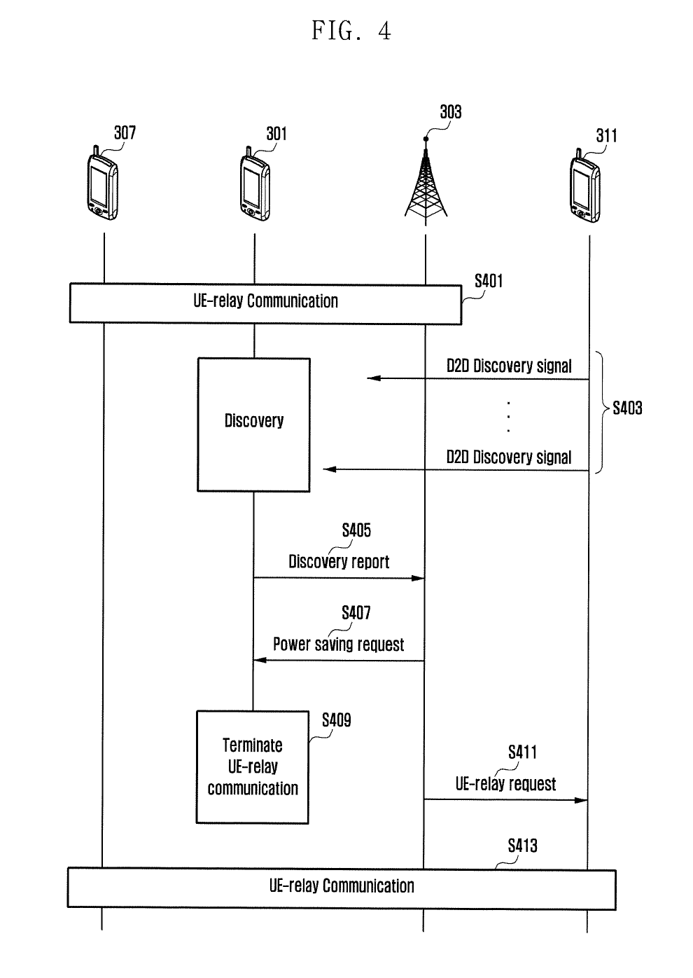

FIG. 4 is a flowchart illustrating an example method of UE-relay communication for reducing power consumption according to this disclosure. According to an embodiment of the present disclosure, the relay terminal that performs UE-relay communication and controls other terminals, determines the status of nearby relay terminals through the discovery operation in the D2D communication. Here, if reduction of power consumption is needed, the relay terminal tosses the terminal that is being served by the relay terminal to another relay terminal, and then enters a power saving mode.

Referring to FIG. 4, the relay terminal 301 performs relay communication and serves at least one of other terminals 307 in block 5401. The relay terminal 301 transmits and receives data to and from the base station 303 through backhaul link, and the relay terminal 301 periodically transmits reference signals and data for the terminal 307 that are being served by the terminal 301. The relay terminal 301 performs the D2D discovery operation during the service for the terminals 307 through the UE-relay communication in S403. The relay terminal 301 periodically broadcasts its information as discovery signals, or searches for (or listens to) discovery signals periodically broadcasted by the nearby relay terminals 311.

The D2D discovery signal includes at least one of a terminal identifier, MAC address, the type of terminal, operation capability, or service category. Particularly, in the embodiment of the present disclosure, the D2D discovery signal includes information such as power status, channel status, support of UE-relay communication, UE-relay communication status, and the possibility of service for other terminals. If the D2D discovery signal not including information on power status or the possibility of serving other terminals is detected, the relay terminal 301 detects that other relay terminals 311 (that are serving at least one of other terminals at the moment or that are capable of serving other terminals) exist near thereto. If the D2D discovery signal including information on power status or possibility of service of other terminals is detected, in addition to detection of the existence of the nearby relay terminal 311, the relay terminal 301 detects power status or channel status of the nearby relay terminal 311, and detects whether or not the nearby relay terminal 311 serves the terminal 307 that is being served by the relay terminal 301.

The relay terminal 301 periodically performs the D2D discovery operation. In this case, the relay terminal 301 shares a predetermined cycle with the nearby relay terminal 311 for the D2D discovery operation. Therefore, the base station 303 is relieved of a burden of allotment of a specific pattern for detecting the nearby relay terminals.

In an embodiment of the present disclosure, the relay terminal 301 performs the D2D discovery operation only when the status of the relay terminal 301 matches a predetermined condition. For example, the relay terminal 301 determines whether or not the D2D discovery operation should be performed based on channel status with the base station 303 and/or battery status thereof. If the channel status with the base station 303 is not good or the amount of remaining battery is less than a critical value, the relay terminal 301 may not perform the D2D discovery operation. However, even with bad channel status with the base station 303 and low battery power, in the case of entering into a power saving mode and tossing the terminal 307 that is being served by the relay terminal 301 to another relay terminal 311 near thereto, the relay terminal 301 performs the D2D discovery operation. As described herein, the predetermined condition is configured by the user or terminal manufacturers to be pre-stored in the relay terminal 301.

In an embodiment of the present disclosure, in transmitting discovery signals, the relay terminal 301 and the nearby relay terminal 311 transmits the discovery signals at the level of power less than a predetermined critical value. More specifically, the relay terminal 301 and the nearby relay terminal 311, considering their service coverage and the service coverage of other relay terminals near thereto, determines the level of transmission power. For example, only if the terminal 307, which has been served by the nearby relay terminal 311 within the service coverage thereof, exists within the service coverage of the relay terminal 301, the relay terminal 301 takes over the terminal 307 to serve the same.

It is assumed that the terminal 307 is within the service coverage of the relay terminal 301, but is not within the service coverage of the nearby relay terminal 311. That is, the relay terminal 301 is positioned out of the service coverage of the nearby relay terminal 311. If the nearby relay terminal 311 transmits the discovery signal at maximum transmission power, the relay terminal 311 detects the relay terminal 301 positioned out of the service coverage thereof. As a result of the detection, the relay terminal 301 tosses the terminal 307 that is being served by the relay terminal 301 to the nearby relay terminal 311. In this case, since the terminal 307 is not within the service coverage of the nearby relay terminal 311, communication thereof is disconnected.

Accordingly, the nearby relay terminal 311 transmits the discovery signal using the level of transmission power less than the predetermined critical value, not the maximum transmission power, so that the relay terminals positioned out of the service coverage of the nearby relay terminal 311 may not be detected. In FIG. 3, if the relay terminal 301 is positioned in the center of the service coverage of the nearby relay terminal 311, the terminal 307 that is being served by the relay terminal 301, is positioned in the service coverage of the nearby relay terminal 311.

In order to make the service coverage of the nearby relay terminal 311 include the terminal 307 that is to be tossed from the relay terminal 301, the nearby relay terminal 311 should transmit the discovery signal at low power so that only the relay terminals that are positioned in the center of the service coverage of the nearby relay terminal is detected. Therefore, based on at least one of the service coverage of the nearby relay terminal 311 or the service coverage of the relay terminal 301, the nearby relay terminal 311 determines the critical value of the signal transmission power so that the terminal that is being served by the relay terminal 301 is positioned within the service coverage of the nearby relay terminal 311, and the nearby relay terminal 311 transmits the discovery signal using the level of signal transmission power less than the critical value. The relay terminal 301 reports the discovery result to the base station 303 in S405.

In an embodiment, in the case of the D2D discovery signal that does not include the information on the terminal power status, that is, in the case in which the D2D discovery signal is used only for identifying existence of the nearby relay terminal 311, the relay terminal 301 reports information on the nearby terminal to the base station 303. In the case of the D2D discovery signal that does not include the information on the terminal power status, the relay terminal 301 cannot determine the channel status and the power status of the nearby serving terminals through the received discovery signal, so the relay terminal 301 reports the discovery result to the base station 303.

The discovery report in S405 of the relay terminal 301 includes information on the nearby relay terminal 311, which is included in the received discovery signal, and information on the relay terminal 301. The information on the relay terminal 301 includes information such as power status, channel status, support of UE-relay communication, UE-relay communication status, and possibility of service for other terminals of the relay terminal 301.

The base station 303 receives the D2D discovery result from the relay terminal 301, and determines whether or not the relay terminal 301 should enter the power saving mode. In addition, the base station 301 determines the channel status and the power status of the nearby relay terminal 311, based on the reported information, and determines whether or not to at least one of other terminals 307 that are being served by the relay terminal 301 should be tossed to the nearby relay terminal 311.

If it is determined that the relay terminal 301 should enter the power saving mode, the base station 303 transmits an instruction for entry into the power saving mode to the relay terminal 301 in S407.

If the power status of the current relay terminal 301 is not good (such as because of low battery power) and the nearby relay terminal 311 has relatively good power status, the base station 303 transmits the instruction for entry into the power saving mode to the relay terminal 301. The format or the content of the instruction for entry into the power saving mode, which is transmitted by the base station 303, is not limited and is made in various manners. For example, the instruction for entry into the power saving mode responds to a request for termination of UE-relay communication or a request for termination of service for the terminal 307.

In various embodiments, the discovery report of the relay terminal 301 is omitted. In addition, the instruction for entry into the power saving mode, which is transmitted from the base station 303, is omitted. More specifically, the discovery report of the relay terminal 301 and the instruction for entry into the power saving mode is omitted when the D2D discovery signal includes information such as power status, channel status, or possibility of service for the terminal 307 of the nearby relay terminal 311. In this case, the relay terminal 301 may not report the discovery result to the base station 303, and determines by itself whether or not it should enter the power saving mode to thereby operate according to the determination.

More specifically, if the power status of the relay terminal 301 is not good and the relay terminal 301 is serving only a small number of terminals 307, the relay terminal 301 identifies the existence of the nearby relay terminal 311 that has sufficient battery power or a good link status with the base station 303, using the information included in the discovery signal. The relay terminal 301 tosses the terminal 307 that is being served by the relay terminal 301 to the nearby relay terminal 311 directly or through the base station 303, to thereby reduce power consumption thereof. The nearby relay terminal 311 that takes over the terminal 307 for service from the relay terminal 301 is determined by the base station 303, or is selected by the relay terminal 301. The relay terminal 301 tosses the terminal 307 that is being served by the relay terminal 301 to the determined (or selected) nearby relay terminal 311 by direct data-communication with the nearby relay terminal 311 or through the base station 303.

If the entry into the power saving mode is required or the instruction of entry into the power saving mode is received, the relay terminal 301 terminates the UE-relay communication in block S409. In an embodiment, the relay terminal 301 terminates serving for the terminal 307. The relay terminal 301 stops serving for at least one of other terminals 307 to reduce power consumption. In various embodiments, the base station 303 tosses the terminal 307 that is being served by the relay terminal 301 to the nearby relay terminal 311 that has relatively good power status. The base station 303 makes a request to the nearby relay terminal 311, of which status has been reported, for performing the UE-relay communication in S411. The base station 303 makes a request to the nearby relay terminal 311 for serving the terminal 307 that has been served by the relay terminal 301. The nearby relay terminal 311 requested for service by the base station 303 makes UE-relay communication, serving the terminal 307 that has been served by the relay terminal 301 in block S413.

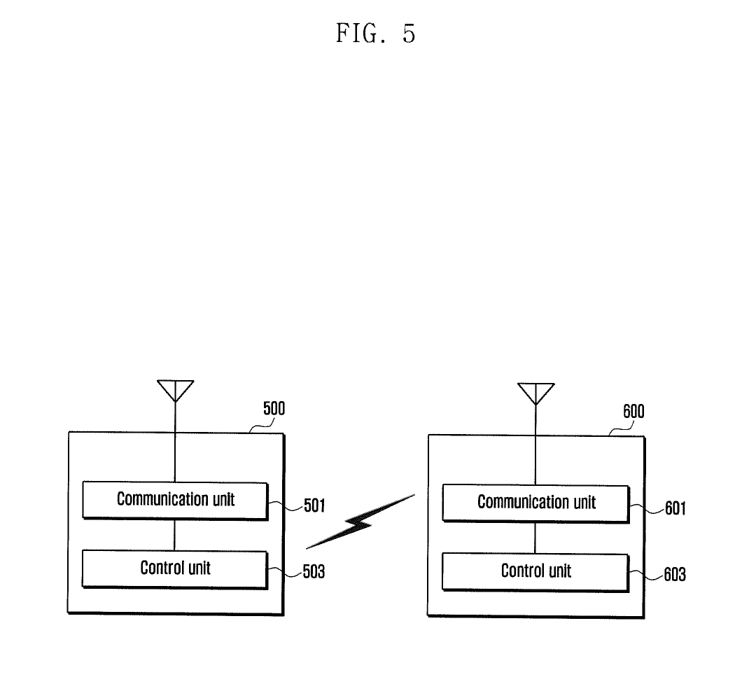

FIG. 5 is a block diagram of an example terminal and an example base station according to this disclosure. Referring to FIG. 5, the terminal 500 includes a communication unit 501 and a control unit 503. The communication unit 501 transmits and receives data to and from nearby terminals. At this time, the communication unit 501 makes data-communication with other relay terminals that are positioned near to the terminal 500 and that are able to perform the relay operation.

The communication unit 501 broadcasts discovery signals to the nearby terminals or receives the discovery signals from the nearby relay terminals under the control of the control unit 503. The control unit 503 controls elements of the terminal 500 for the relay operation. For example, the control unit 503 controls the communication unit 501 to transmit or receive the discovery signals. In addition, the control unit 503 determines the status of other relay terminals, based on the received discovery signals, and if necessary, the control unit 503 tosses the terminal that is being served to other relay terminals. The more detailed operation of the control unit 503 is the same as described above.

The terminal 500 set forth above operates as the relay terminal for serving other terminals, or is the terminal that is served by other terminals, in some cases. Alternatively, the terminal 500 takes over the terminal for service from the nearby relay terminal. The base station 600 includes a communication unit 601 and a control unit 603. The communication unit 601 transmits and receives data to and from at least one relay terminal. The control unit 603 controls the communication unit 601 to allow at least one relay terminal to transmit and receive data for UE-relay communication. The control unit 603 helps with the control of the relay terminals for serving the terminals, based on the information of the relay terminals.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A relay communication method of a terminal, the method comprising:
performing relay communication to serve at least one other terminal;
performing a device-to-device (D2D) discovery operation to detect a nearby relay terminal during the relay communication; and
if the nearby relay terminal that satisfies a predetermined condition is detected as a result of the D2D discovery operation, terminating service to at least the one other terminal.

2. The method of claim 1, wherein performing the D2D discovery operation comprises receiving a discovery signal from at least one nearby relay terminal, wherein the discovery signal includes at least one of a channel status, a power status, a battery status, or a relay communication status of at least the one nearby relay terminal.

3. The method of claim 2, wherein terminating service comprises:
determining whether the nearby relay terminal that is able to serve the at least one terminal exists based on the information; and
if the nearby relay terminal that is able to serve the at least one terminal exists, tossing the at least one terminal to the nearby relay terminal.

4. The method of claim 1, wherein terminating service comprises:
reporting a discovery result to a base station; and
if a request to terminate service is received from the base station, terminating the service to at least the one other terminal.

5. The method of claim 1, wherein performing the D2D discovery operation comprises:
determining whether the D2D discovery operation should be operated based on at least one of a channel status, a power status, or a battery status of the terminal; and
performing the D2D operation according to the determination.

6. The method of claim 1, further comprising entering a power saving mode.

7. The method of claim 2, wherein the discovery signal is received using transmission power that is less than a predetermined critical value.

8. The method of claim 7, wherein the critical value is determined based on at least one of service coverage of the terminal or service coverage of the nearby relay terminal.

9. A terminal comprising:
a communication unit configured to perform data-communication; and
a control unit configured to:
perform relay communication to serve at least one other terminal,
perform a device-to-device (D2D) discovery operation to detect a nearby relay terminal during the relay communication, and
if the nearby relay terminal that satisfies a predetermined condition is detected as a result of the discovery operation, terminate service to at least the one other terminal.

10. The terminal of claim 9, wherein the control unit is configured to control the communication unit to receive a discovery signal from at least one nearby relay terminal, wherein the discovery signal includes at least one of a channel status, a power status, a battery status, or a relay communication status of at least the one nearby relay terminal.

11. The terminal of claim 10, wherein the control unit is configured to control to determine whether the nearby relay terminal that is able to serve the at least one terminal exists based on the information, and if the nearby relay terminal that is able to serve the at least one terminal exists, toss the at least one terminal to the nearby relay terminal.

12. The terminal of claim 9, wherein the control unit is configured to control the communication unit to report a discovery result to a base station, and if a request to terminate service is received from the base station through the communication unit, terminate the service to at least the one other terminal.

13. The terminal of claim 9, wherein the control unit is configured to determine whether the D2D discovery operation should be operated based on at least one of a channel status, a power status, or a battery status of the terminal, and perform the D2D discovery operation according to the determination.

14. The terminal of claim 9, wherein the control unit is configured to enter a power saving mode after terminating service.

15. The terminal of claim 10, wherein the discovery signal is received using transmission power that is less than a predetermined critical value.

16. The terminal of claim 15, wherein the critical value is determined based on at least one of service coverage of the terminal or service coverage of the nearby relay terminal.

17. An apparatus for use in a terminal, the apparatus comprising:
processing circuitry configured to:
control a relay communication to serve at least one other terminal,
execute a device-to-device (D2D) discovery operation to detect a nearby relay terminal during the relay communication, and
if the nearby relay terminal that satisfies a predetermined condition is detected as a result of the discovery operation, terminate service to at least the one other terminal.

18. The apparatus of claim 17, wherein the processing circuitry is configured to control the communication unit to receive a discovery signal from at least one nearby relay terminal, wherein the discovery signal includes at least one of a channel status, a power status, a battery status, or a relay communication status of at least the one nearby relay terminal.

19. The apparatus of claim 18, wherein the processing circuitry is configured to determine whether the nearby relay terminal that is able to serve the at least one terminal exists based on the information, and if the nearby relay terminal that is able to serve the at least one terminal exists, toss the at least one terminal to the nearby relay terminal.

20. The apparatus of claim 17, wherein the processing circuitry is configured to control the communication unit to report a discovery result to a base station, and if a request to terminate service is received from the base station through the communication unit, terminate the service to at least the one other terminal.
